(19) United States
(12) Patent Application Publication
(10) Pub. No.: US 2016/0060404 A1
(43) Pub. Date: Mar. 3, 2016

(54) POLYIMIDE FILM ARRANGEMENT, AND MANUFACTURE AND ASSEMBLY THEREOF

(71) Applicant: Taimide Technology Incorporation, Hsinchu County (TW)

(72) Inventors: Chih-Wei Lin, Hsinchu Hsien (TW); Chun-Ting Lai, Hsinchu Hsien (TW); Yen-Po HUANG, Hsinchu Hsien (TW)

(21) Appl. No.: 14/839,654

(22) Filed: Aug. 28, 2015

(30) Foreign Application Priority Data
Aug. 29, 2014 (TW) 103129968
Mar. 5, 2015 (TW) 104106959

(51) Int. Cl. C08J 5/18; B32B 37/16; B05D 7/04; B29C 65/00; B05D 3/02; B05D 3/12; B32B 27/28; B32B 38/10

(52) U.S. Cl. CPC C08J 5/18; B32B 27/281; B32B 37/16; B32B 38/10; B29C 66/41; B29C 66/71; B05D 3/0254; B05D 3/12; B05D 7/04; B32B 2264/0242; B32B 2260/02; B32B 2457/08; B29L 2031/3425

(57) ABSTRACT

A polyimide film arrangement (e.g., a polyimide film) includes a polyimide layer having a first and a second surface opposite to each other, and a base layer peelably adhered to the first surface of the polyimide layer and containing a polyimide. The polyimide layer or the base layer includes a filler having a surface energy less than about 35 dyne/cm. Moreover, the present application also describes a method of fabricating the polyimide film arrangement, and its assembly on a substrate.

### CROSS-REFERENCE TO RELATED APPLICATIONS

This application respectively claims priority to Taiwan Patent Application No. 103129968 filed on Aug. 29, 2014, and to Taiwan Patent Application No. 104106959 filed on Mar. 5, 2015, the disclosures of which are incorporated herein by reference.

### BACKGROUND OF THE INVENTION

1. Field of the Invention

The present application generally relates to polyimide films, and more particularly to ultra-thin polyimide films and the manufacture and assembly thereof.

2. Description of the Related Art

A polyimide coverlay may be used in a print circuit board (PCB) to cover and protect metal circuits formed thereon. As technology advances, the printed circuit board becomes increasingly thinner, lighter and multi-functional. Moreover, the thinner dimension of the printed circuit board may require the use of an ultra-thin polyimide coverlay.

Ultra-thin polyimide films are difficult to fabricate with current processing methods. Some polyimide films may have a thickness less than 10 μm. However, polyimide films with a thickness less than 5 μm may not be subjected to biaxial orientation, because the stretching process may break the polyimide film. Moreover, the fabrication of some ultra-thin polyimide films may have not considered difficulties that may arise during the assembly of the polyimide film on the substrate of the printed circuit board.

Accordingly, there is a need for ultra-thin polyimide films that are convenient to process, and address at least the foregoing issues.

### SUMMARY

The present application describes a polyimide film arrangement (e.g., a polyimide film) that can be fabricated according to a cost-effective manner, and address at the foregoing problems. In some embodiments, the polyimide film arrangement includes a polyimide layer having a first and a second surface opposite to each other, and a base layer containing a polyimide that is peelably adhered to the first surface of the polyimide layer.

The present application also describes a method of fabricating a polyimide film arrangement. In some embodiments, the method includes preparing a base layer containing a polyimide and a filler having a surface energy less than about 35 dyne/cm, coating a surface of the base layer with a polyamic acid solution, and heating the polyamic acid solution to form a polyimide layer on the base layer, the base layer and the polyimide layer forming a polyimide film arrangement in which the base layer is peelably adhered to the polyimide layer.

In addition, the present application further provides a method of assembling a polyimide layer. The method includes providing a polyimide film arrangement including a polyimide layer having a first and a second surface opposite to each other, and a base layer containing a polyimide that is peelably adhered to the first surface of the polyimide layer. Subsequently, the polyimide film arrangement is placed on a substrate such that the second surface of the polyimide layer is adhered to the substrate, and while the polyimide layer remains adhered to the substrate, the base layer is then peeled off from the first surface of the polyimide layer.

### BRIEF DESCRIPTION OF THE DRAWINGS

FIG. 1 is schematic views illustrating an embodiment of a polyimide film arrangement; and

FIGS. 2A through 2D are schematic views illustrating intermediate stages in a method of assembling the polyimide arrangement with a substrate.

### DETAILED DESCRIPTION OF THE EMBODIMENTS

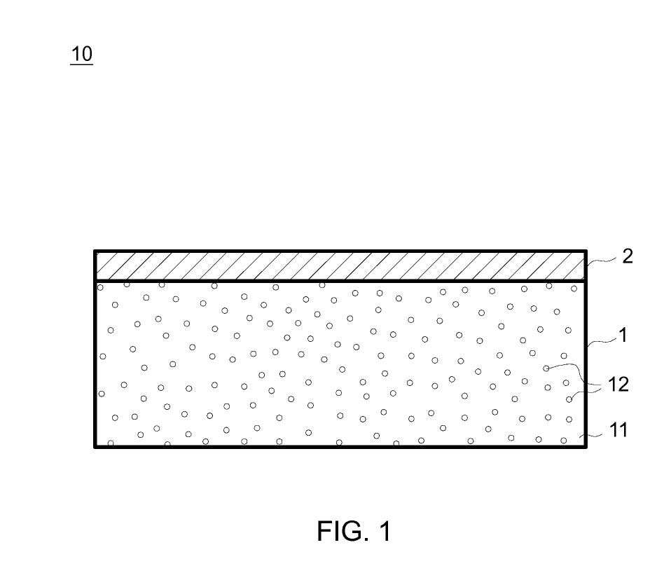

FIG. 1 is a schematic view illustrating an embodiment of a polyimide film arrangement 10 (e.g., a polyimide film). The polyimide film arrangement 10 includes a base layer 1, and a polyimide layer 2 that adheres and contacts with a surface of the base layer 1. The polyimide layer 2 is formed as a single ultra-thin layer containing polyimide as base material. The polyimide layer 2 has a thickness less than about 6 μm. More specifically, the thickness of the polyimide layer 2 is preferably less than about 5 μm, for example between 0.1 μm and 5 μm. In some embodiments, the thickness of the polyimide layer 2 can be 0.1 μm, 1 μ, 2 μm, 2.5 μm, 3 μm, 4 μm, 4.5 μm, or any intermediate values falling in any ranges defined between any of the aforementioned values.

The base layer 1 is a single layer containing polyimide as base material. While there is no particular constraints imposed on the thickness of the base layer 1, some embodiments provide a base layer 1 that preferably has a thickness greater than the thickness of the polyimide layer 2. In some embodiments, the thickness of the base layer 1 can be between about 5 μm and about 10 μm. In other embodiments, the thickness of the base layer 1 can be greater than 10 μm. Since the polyimide layer 2 is an ultra-thin layer, the base layer 1 can provide support to the polyimide layer 2 and facilitate its processing and assembly.

The base layer 1 or the polyimide layer 2 can contain a filler having a surface energy sufficiently low so as to allow the base layer 1 and the polyimide layer 2 to peelably adhere to each other. In the illustrated embodiment, the base layer 1 is a single layer containing polyimide and a filler 12 in the form particles dispersed in the polyimide of the base layer 1. The filler 12 has a low surface energy less than about 35 dyne/cm. Suitable materials for the filler 12 contain a carbon-fluorine (C-F) bond or a silicon-oxygen (Si—O) bond. Examples of the filler 12 containing a carbon-fluorine bond include fluoropolymers, and examples of the filler 12 containing a silicon-oxygen bond include siloxane polymers. The base layer 1 containing the filler 12 as described herein can have a surface energy less than about 35 dyne/cm, which reduces the adhesiveness of the base layer 1 to the polyimide layer 2 and thereby allows the base layer 1 to be peelably adhered to the polyimide layer 2.

While the illustrated embodiment shows the filler 12 in the base layer 1 only, alternate embodiments may incorporate the same filler 12 in the polyimide layer 2 rather than in the base layer 1. In other embodiments, the filler 12 may also be incorporated in both the base layer 1 and the polyimide layer 2.

In some embodiments, fluoropolymers used as the filler 12 can include fluorinated polyalkene, fluoro-substituent polyalkane, fluoro-substituent poly alkyl oxygen, chlorofluorocarbons, or the like.

In other embodiments, fluoropolymers used as the filler 12 can include polyvinylfluoride (PVF), polyfluorinated vinylidene (PVDF), polytetrafluoroethylene (PTFE), polyfluorinated ethylene propylene (FEP), perfluoropolyether (PEPE), perfluorosulfonic acid (PF SA) polymer, perfluoroalkoxy (PFA) polymer, chlorotrifluoroethylene (CTFE) polymer, ethylene chlorotrifuloroethylene (ECTFE) polymer, or the like, which can be used individually or in combination.

In some embodiments, the filler 12 can be present in the base layer 1 at a weight ratio between about 45 wt % and about 60 wt % based on the total weight of the base layer 1. For example, the weight ratio of the filler 12 can be 46 wt %, 48 wt %, 50 wt %, 55 wt %, 58 wt %, or any intermediate values falling in any ranges defined between any of the aforementioned values. In some embodiments, the weight ratio of the filler 12 containing fluorine can be exemplary between about 45 wt % and about 55 wt % of the total weight of the base layer 1. In some variant embodiments, the weight ratio of the filler 12 can be between about 55 wt % and about 60 wt % of the total weight of the base layer 1. In yet other embodiments, the weight ratio of the filler 12 can be between about 47 wt % and about 57 wt % the total weight of the base layer 1.

The filler 12 is in the form of particles having an average particle diameter or size less than about 20 μm. For example, the average particle diameter of the filler 12 can be 0.5 μm, 1 μm, 2.5 μm, 5 μm, 7.5 μm, 10 μm, 12.5 μm, 15 μm, 17.5 μm, 19 μm, 20 μm, or any intermediate values falling in any ranges defined between any of the aforementioned values. In some embodiments, the average particle diameter of the filler 12 is between about 5 μm and about 15 μm. In some variant embodiments, the average particle diameter of the filler 12 is between about 1 μm and about 10 μm, preferably between 2 μm and 8 μm. In still other embodiments, the filler 12 has an average particle diameter between about 11 μm and about 20 μm, preferably between 12 μm and 18 μm. In yet other embodiments, the filler 12 has an average particle diameter between 6 μm and 15 μm.

By incorporating a suitable amount of a filler having low surface energy (e.g., less than about 35 dyne/cm) in the base layer 1, it can be observed that the base layer 1 exhibits reduced surface tension so that the adhesiveness of the base layer 1 to the polyimide layer 2 is reduced. However, the addition of the filler having low surface energy in the base layer 1 still allows to produce a desirable surface tension of the base layer 1, so that the polyimide layer 2 can be directly formed on a surface of the base layer 1. Accordingly, when the polyimide film arrangement 10 comprised of the base layer 1 and the polyimide layer 2 undergoes subsequent processing (e.g., attachment to a substrate), the base layer 1 can be entirely and easily peeled off from the polyimide layer 2. For example, after the polyimide layer 2 is adhered to a copper foil for preparing a printed circuit board, the base layer 1 can be directly peeled off leaving the polyimide layer 2 adhered to the copper foil. This separation of the base layer 1 can be easily done without breaking the polyimide layer 2 or separating it from the copper foil.

In some embodiments, a peel strength between the ultra-thin polyimide layer 2 and the base layer 1 is less than about 0.15 kgf/cm (kilogram-force per cm), e.g., 0.14 kgf/cm, 0.12 kgf/cm, 0.10 kgf/cm, 0.05 kgf/cm, or any intermediate values falling in any ranges defined between any of the aforementioned values. The aforementioned ranges of the peel strength between the polyimide layer 2 and the base layer 1 reflect the peelable adhesion of the base layer 1 to the polyimide layer 2.

In at least one embodiment, the base layer 1 further has a water contact angle higher than 40°, e.g., 50°, 60°, 75°, 90°, 120°, 150°, 180°, or any intermediate values falling in any ranges defined between any of the aforementioned values.

Referring to FIG. 1, a method of manufacturing the polyimide film arrangement 10 includes preparing the base layer 1, coating a surface of the base layer 1 with a polyamic acid solution, and apply heat to convert the polyamic acid solution on the base layer 1 into the polyimide layer 2.

For preparing the base layer 1, selected diamine and dianhydride monomers can be mixed in a solvent to form a first polyamic acid solution, and the filler 12 in the form of powder is then incorporated and homogeneously mixed in the first polyamic acid solution. The obtained mixture is coated on a glass or stainless steel plate, and then baked at a temperature between about 90° C. and about 350° C. The base layer 1 thereby formed contains polyimide as base material, and particles of the filler 12 having lower surface energy dispersed in the polyimide of the base layer 1.

For forming the polyimide layer 2, selected diamine and dianhydride monomers are incorporated and mixed in a solvent to form a second polyamic acid solution. The diamine and dianhydride monomers used for the polyimide layer 2 can be the same, partly the same, or different from the diamine and dianhydride monomers used for forming the base layer 1. Additives, e.g., a pigment and/or matting agent, can be added in the second polyamic acid solution. The second polyamic acid solution is coated onto a surface of the base layer 1, and then baked at a temperature between about 90° C. and about 350° C. to form the polyimide layer 2 on the base layer 1. The polyimide layer 2 has a thickness preferably less than about 5 μm, e.g., between about 0.1 μm and about 5 μm. A polyimide film arrangement comprised of the base layer 1 and the polyimide layer 2 adhered to each other can be thereby formed, the base layer 1 being peelable from the polyimide layer 2.

In certain embodiments, the polyimide film arrangement 10 comprised of the base layer 1 and the polyimide layer 2 can further undergo a biaxial stretching process so that both the base layer 1 and the polyimide layer 2 are biaxially oriented, e.g., along the lengthwise and transversal directions of the polyimide film arrangement. This can enhance the strength of the base layer 1 and the polyimide layer 2.

Biaxial stretching may be more difficult for thinner films, and most ultra-thin polyimide films may not be subjected to biaxial stretching. Because it is formed with the ultra-thin polyimide layer 2 directly adhered on the base layer 1, the polyimide film arrangement 10 described herein can have a suitable thickness so that the biaxial stretching process can be applied without breaking the ultra-thin polyimide layer 2.

The polyimide film arrangement 10 described herein can be formed by thermal conversion or chemical conversion. When chemical conversion is used, a dehydrant or a catalyst can be added into the polyamic acid solution before the coating step. The solvent can be non-polar and aprotic solvent, e.g., dimethylacetamide (DMAC), N, N′-dimethylformamide (DMF), N-methyl-2-pyrrolidone (NMP), dimethyl sulfoxide (DMSO), tetramethylene sulfone, N,N′-dimethyl-N,N′-propylene urea (DMPU), and the like. The dehydrant can be aliphatic anhydride (e.g., acetic anhydride and propionic anhydride), aromatic anhydride (e.g., benzoic acid anhydride and phthalic anhydride), and the like. The catalyst can be heterocyclic tertiary amine (e.g., picoline, pyridine, and the like), aliphatic tertiary amine (e.g., trimethylamine (TEA) and the like), aromatic tertiary amine (e.g., xylidine and the like), etc. The molar ratio of polyamic acid: dehydrant: catalyst is 1:2:1. That is, for each mole of polyamic acid solution, about 2 moles of dehydrant and about 1 mole of catalyst are used.

In at least one embodiment, the polyimide is formed by condensation reaction of diamine and dianhydride monomers at a substantially equal molar ratio (i.e., 1:1), e.g., the diamine-to-dianhydride molar ratio can be 0.9:1.1 or 0.98:1.02.

The polyimide of the base layer 1 and the polyimide of the polyimide layer 2 may be formed by reacting diamine monomers with dianhydride monomers.

Examples of the diamine monomers can include 4,4′-oxydianiline (4,4′-ODA), p-phenylenediamine (p-PDA), 2,2′-bis(trifluoromethyl)benzidine (TFMB), 1,3-bis(4-aminophenoxy)benzene (TPER), 1,4-bis(4-aminophenoxy)benzene (TPEQ), 2,2′-dimethyl-4,4′-diaminobiphenyl (m-TB-HG), 1,3′-bis(3-aminophenoxy) benzene (APBN), 3,5-diaminobenzotrifluoride (DABTF), 2,2′-bis[4-(4-aminophenoxy) phenyl]propane (BAPP), 6-amino-2-(4-aminophenyl)benzoxazole (6PBOA), or 5-amino-2-(4-aminophenyl)benzoxazole (5PBOA), which can be used individually or in combination.

Examples of the dianhydride monomers can include 3,3′,4,4′-biphenyl-tetracarboxylic dianhydride (BPDA), 2,2-bis [4-(3,4dicarboxyphenoxy) phenyl] propane dianhydride (BPADA), pyromellitic dianhydride (PMDA), 2,2′-bis-(3,4-dicarboxyphenyl) hexafluoropropane dianhydride (6FDA), 4,4-oxydiphthalic anhydride (ODPA), benzophenonetetracarboxylic dianhydride (BTDA), or 3,3′,4,4′-dicyclohexyl-tetracarboxylic acid dianhydride (HBPDA), which can be used individually or in combination.

In some embodiments, the diamine monomers used for forming the polyimide of the base layer 1 can include 4,4′-ODA, p-PDA, or TFMB, which can be used individually or in combination. Moreover, the dianhydride monomers used for forming the polyimide of the base layer 1 can include PMDA, BPDA, or BPADA, which can be used individually or in combination.

The diamine and dianhydride monomers used for forming the polyimide layer 2 can be similar, partly similar, or different from those used for forming the base layer 1. In some embodiments, the diamine monomers used for the polyimide layer 2 can include 4,4′-ODA, p-PDA, or TFMB, which can be used individually or in combination. Moreover, the dianhydride monomers used for the polyimide layer 2 can include PMDA, BPDA, or BPADA, which can be used individually or in combination.

The present disclosure also provides a method of assembling the polyimide film arrangement 10, which includes placing the polyimide film arrangement on a substrate such that the polyimide layer 2 is adhered to the substrate, and then peeling the base layer 1 off from the polyimide layer 2. The substrate can be a printed circuit board, a laminate structure, a base substrate or the like.

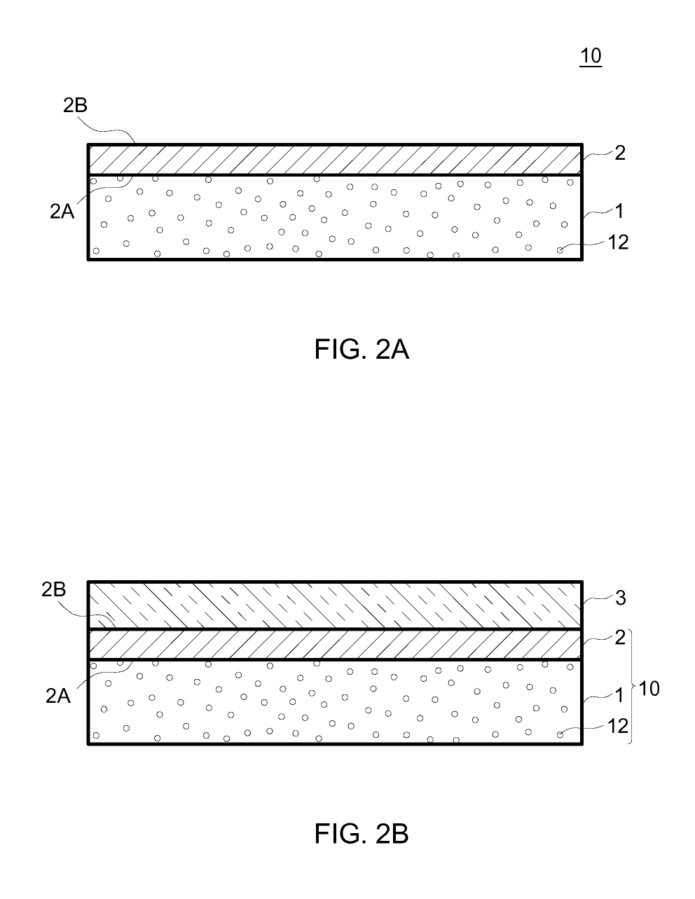

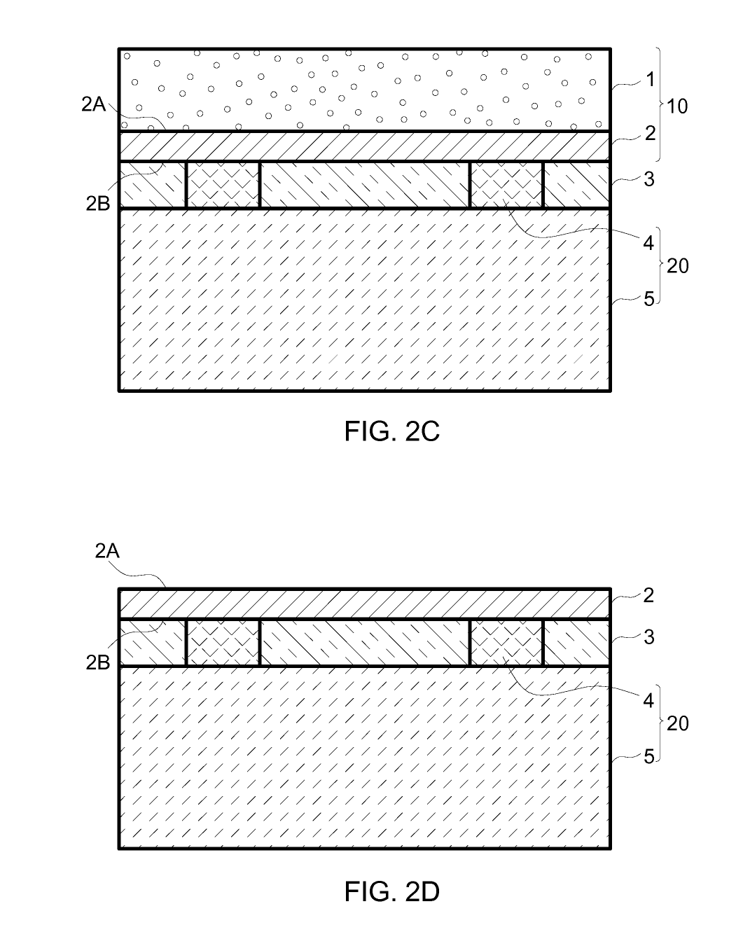

FIGS. 2A-2D are schematic views illustrating an embodiment of a method of assembling the polyimide film arrangement with a substrate 20. Referring to FIG. 2A, a polyimide film arrangement 10 including the base layer 1 and the polyimide layer 2 adhered to each other is provided. The polyimide layer 2 has a first surface 2A and a second surface 2B opposite to each other. The first surface 2A of the polyimide layer 2 directly contacts with and adheres to a surface of the base layer 1, while the second surface 2B of the polyimide layer 2 is exposed.

Referring to FIG. 2B, an adhesive substance is applied on the second surface 2B of the polyimide layer 2 to form an adhesive layer 3.

Referring to FIG. 2C, the polyimide film arrangement 10 is then placed a substrate 20 so that the second surface 2B of the polyimide layer 2 adheres to the substrate 20. The substrate 20 can be a printed circuit board, which includes a metal layer 4 and a base substrate 5.

Referring to FIG. 2D, while the polyimide layer 2 remains adhered to the substrate 20, the base layer 1 is peeled off from the first surface 2A of the polyimide layer 2.

Examples of methods of fabricating the aforementioned polyimide film arrangement are described hereinafter.

### EXAMPLES

About 52.63 g of 4,4′-ODA and about 440 g of DMAC used as solvent are put into a three-necked flask, and agitated at a temperature of about 30° C. until complete dissolution. Then about 57.37 g of PMDA is added into the obtained solution. The quantity of the reacted monomers is 20 wt % of the total weight of the solution. The solution is continuously agitated and reaction occurs at a temperature of 25° C. for 20 hours to form a first polyamic acid (PAA) solution. About 100 g of PTFE powder (i.e., 45 wt % based on the total weight of the base layer 1) is then added as a filler into the first PAA solution and agitated to obtain a homogeneous mixture. Subsequently, acetic anhydride and picoline are added as catalysts into the first PAA solution (the molar ratio of the first PAA solution: acetic anhydride:picoline is about 1:2:1). After de-bubbling, the solution is coated onto a glass plate and baked at 80° C. for 30 minutes to remove most of the solvent. Then, the glass plate with the coated PAA solution thereon is placed in an oven and baked at 170° C. for 1 hour to form the base layer 1.

Subsequently, the ultra-thin polyimide layer 1 is prepared with a similar method as described previously. About 52.63 g of 4,4′-ODA and about 57.37 g of PMDA are reacted to form a second polyamic acid (PAA) solution. The quantity of the reacted monomers is 20 wt % based on the total weight of the second PAA solution. After de-bubbling, the second PAA solution is coated onto the base layer 1, and both the base layer 1 and the coated layer of the second PAA solution are baked at a temperature of 80° C. for about 30 minutes.

The wet film composed of the base layer 1 and the ultra-thin polyimide layer 2 then is extracted, and affixed on a stretching machine having pin plates at four corners to undergo biaxial stretching. The wet film comprised of the base layer 1 and the polyimide layer 2 has an initial width L₀ₓ and an initial length L_{0y}, which respectively become a width Lₓ and a length L_{y} after stretching. A width stretching rate (εₓ) can be defined as the expression (Lₓ-L₀ₓ)/L₀ₓ, and a length stretching rate (ε_{y}) can be defined as the expression (L_{y}-L_{0y})/L_{0y}. In one embodiment, Eₓ and E_{y} can be respectively equal to about 40%.

After the biaxial stretching process is completed, the wet film is baked at a temperature between 170° C. and 350° C. for 4 hours.

The final polyimide film arrangement has a total thickness equal to about 27.5 μm, the thickness of the base layer 1 being about 25 μm and the thickness of the ultra-thin polyimide layer 2 being about 2.5 μm.

Test of the Film Properties

Measure of Water Contact Angle:

A sessile drop technique (DSA10-MK2, Kruss) is applied to measure the water contact angle. A light beam is used to illuminate a water drop, which is imaged by a charge coupling device (CCD) sensor on a monitor. An analysis program is then run to calculate the contact angle of the water drop. The error tolerance of the calculation is ±5°.

Test of Peel Strength:

A glue layer is applied on the surface of the ultra-thin polyimide layer 2, and a copper foil of about 18 μm in thickness is pressed thereon. Testing is then conducted with a universal testing machine (Hounsfield H10ks) according to IPC-TM650 2.4.9 test method. It is then verified that peeling occurs at the interface between the base layer 1 and the polyimide layer 2.

The water contact angle of the polyimide film arrangement prepared by the aforementioned examples is about 45 degrees, and the peel strength between the ultra-thin polyimide layer 2 and the base layer 1 is about 0.14 kgf/cm.

### Comparative Example 1

A polyimide film arrangement is prepared as described previously, except that the PTFE powder incorporated in the first PAA solution is 42.4 g (30 wt % based on the total weight of the base layer).

The polyimide film arrangement prepared according to Comparative Example 1 has a water contact angle equal to about 32 degrees, and a peel strength between the base layer 1 and the polyimide layer 2 equal to about 0.5 kgf/cm. The higher peel strength of the polyimide film arrangement fabricated according to Comparative Example 1 means that the polyimide layer cannot be easily separated from the base layer.

### Comparative Example 2

A polyimide film arrangement is prepared as described previously, except that the PTFE powder incorporated in the first PAA solution is 231 g (70 wt % based on the total weight of the base layer).

In Comparative Example 2, no polyimide layer is formed on the base layer. This is because the fluorine content in the base layer is too high, which results in a excessively low surface energy of the base layer.

The polyimide film arrangement described herein can bring several advantages over conventional polyimide films. For example, the smallest thickness of some polyimide films prepared with biaxial stretching may be about 10 μm (with no base layer). If the polyimide film were to be formed with a thickness less than 10 μm, some processing methods may require to laminate the thinner polyimide film on a polyester tape (e.g., PET tape), and then wind the assembly of the polyimide film and the PET tape to form a roll. Unlike a conventional polyimide film assembly, the polyimide film arrangement described herein can accommodate an ultra-thin polyimide layer that is less than 5 μm in thickness, and allow biaxial stretching of the ultra-thin polyimide layer without incurring damages. After it is fabricated, the polyimide film arrangement described in the present disclosure can be wound to form a roll that can be used in downstream processing steps.

Moreover, the polyimide film arrangement described herein can facilitate attachment of the polyimide layer on a substrate, as the base layer can be entirely peeled off from the polyimide layer after it is adhered to the substrate. Accordingly, the polyimide film arrangement can allow convenient processing of an ultra-thin polyimide layer, which can be fabricated at a reduced cost.

Realizations of the polyimide film arrangement and its method of fabrication and assembly have been described in the context of particular embodiments. These embodiments are meant to be illustrative and not limiting. Many variations, modifications, additions, and improvements are possible. These and other variations, modifications, additions, and improvements may fall within the scope of the invention as defined in the claims that follow.

What is claimed is:

1. A polyimide film comprising:
a polyimide layer having a first and a second surface opposite to each other; and
a base layer containing a polyimide that is peelably adhered to the first surface of the polyimide layer.

2. The polyimide film according to claim 1, wherein the polyimide layer has a thickness less than about 6 μm, and the polyimide film comprised of the base layer and the polyimide layer is biaxially oriented.

3. The polyimide film according to claim 1, wherein one of the base layer and the polyimide layer has a surface energy less than about 35 dyne/cm.

4. The polyimide film according to claim 1, wherein a peel strength between the polyimide layer and base layer is less than about 0.15 kgf/cm.

5. The polyimide film according to claim 1, wherein a filler having a surface energy less than about 35 dyne/cm is dispersed in the polyimide layer or the base layer.

6. The polyimide film according to claim 5, wherein the filler is a fluoropolymer or a siloxane polymer.

7. The polyimide film according to claim 5, wherein the filler is selected from a group consisting of polyvinylfluoride (PVF), polyfluorinated vinylidene (PVDF), polytetrafluoroethylene (PTFE), polyfluorinated ethylene propylene (FEP), perfluoropolyether (PEPE), perfluorosulfonic acid (PFSA) polymer, perfluoroalkoxy (PFA) polymer, chlorotrifluoroethylene (CTFE) polymer, ethylene chlorotrifuloroethylene (ECTFE) polymer, and a combination thereof.

8. The polyimide film according to claim 5, wherein the filler is in the form of particles having an average particle diameter less than about 20 μm.

9. The polyimide film according to claim 5, wherein the filler is present in the base layer in a quantity between about 45 wt % and about 60 wt % of a total weight of the base layer.

10. The polyimide film according to claim 1, wherein the polyimide layer has a thickness between about 0.1 μm and about 5 μm.

11. The polyimide film according to claim 1, wherein the polyimide of the base layer is formed by condensation reaction of diamine monomers with dianhydride monomers, the diamine monomers being selected from a group consisting of 4,4′-oxydianiline (4,4′-ODA), phenylenediamine (p-PDA) and 2,2′-Bis(trifluoromethyl)benzidine (TFMB), and the dianhydride monomers being selected from a group consisting of pyromellitic dianhydride (PMDA), 3,3′,4,4′-biphenyltetracarboxylic dianhydride (BPDA), and 2,2-bis [4-(3,4-dicarboxyphenoxy) phenyl] propane dianhydride (BPADA).

12. The polyimide film according to claim 1, wherein the polyimide layer is formed by condensation reaction of diamine monomers with dianhydride monomers, the diamine monomers being selected from a group consisting of 4,4′-oxydianiline (4,4′-ODA), phenylenediamine (p-PDA) and 2,2′-Bis(trifluoromethyl)benzidine (TFMB), and the dianhydride monomers being selected from a group consisting of pyromellitic dianhydride (PMDA), 3,3′,4,4′-biphenyl tetracarboxylic dianhydride (BPDA) and 2,2-bis [4-(3,4-dicarboxyphenoxy) phenyl] propane dianhydride (BPADA).

13. A method of fabricating a polyimide film, comprising:
preparing a base layer containing a polyimide and a filler having a surface energy less than about 35 dyne/cm;
coating a surface of the base layer with a polyamic acid solution; and
heating the polyamic acid solution to form a polyimide layer on the base layer, the base layer and the polyimide layer forming a polyimide film in which the base layer is peelably adhered to the polyimide layer.

14. The method according to claim 13, further comprising:
while the base layer and the polyimide layer are adhered to each other, biaxially stretching the polyimide film.

15. The method according to claim 14, wherein the filler is a fluoropolymer or a siloxane polymer.

16. The method according to claim 13, wherein the filler is selected from a group consisting of polyvinylfluoride (PVF), polyfluorinated vinylidene (PVDF), polytetrafluoroethylene (PTFE), polyfluorinated ethylene propylene (FEP), perfluoropolyether (PEPE), perfluorosulfonic acid (PFSA) polymer, perfluoroalkoxy (PFA) polymer, chlorotrifluoroethylene (CTFE) polymer, ethylene chlorotrifuloroethylene (ECTFE) polymer, and a combination thereof.

17. The method according to claim 13, wherein the filler is in the form of particles having an average particle diameter less than about 20 micrometers.

18. The method according to claim 13, wherein the filler is present in the base layer in a quantity between about 45 wt % and about 60 wt % of a total weight of the base layer.

19. The method according to claim 13, wherein the polyimide layer has a thickness between about 0.1 μm and about 5 μm.

20. The method according to claim 13, wherein the polyimide of the base layer is formed by condensation reaction of diamine monomers with dianhydride monomers, the diamine monomers being selected from a group consisting of 4,4′-oxydianiline (4,4′-ODA), phenylenediamine (p-PDA) and 2,2′-Bis(trifluoromethyl)benzidine (TFMB), and the dianhydride monomers being selected from a group consisting of pyromellitic dianhydride (PMDA), 3,3′,4,4′-biphenyl tetracarboxylic dianhydride (BPDA) and 2,2-bis [4-(3,4 dicarboxyphenoxy) phenyl] propane dianhydride (BPADA).

21. The method according to claim 13, wherein the polyimide layer is formed by condensation reaction of diamine monomers with dianhydride monomers, the diamine monomers being selected from a group consisting of 4,4′-oxydianiline (4,4′-ODA), phenylenediamine (p-PDA) and 2,2′-Bis(trifluoromethyl)benzidine (TFMB), and the dianhydride monomers being selected from a group consisting of pyromellitic dianhydride (PMDA), 3,3′,4,4′-biphenyl tetracarboxylic dianhydride (BPDA) and 2,2-bis [4-(3,4-dicarboxyphenoxy) phenyl] propane dianhydride (BPADA).

22. A method of assembling a polyimide layer, comprising:
providing a polyimide film including a polyimide layer having a first and a second surface opposite to each other, and a base layer containing a polyimide that is peelably adhered to the first surface of the polyimide layer;
placing the polyimide film on a substrate such that the second surface of the polyimide layer is adhered to the substrate; and
while the polyimide layer remains adhered to the substrate, peeling the base layer from the first surface of the polyimide layer.

23. The method according to claim 22, wherein the polyimide layer has a thickness between about 0.1 μm and about 5 μm.

24. The method according to claim 22, wherein the polyimide layer has a thickness less than about 6 μm, and the polyimide film comprised of the base layer and the polyimide layer is biaxially oriented.

25. The method according to claim 22, wherein a peel strength between the polyimide layer and the base layer is less than about 0.15 kgf/cm.

26. The method according to claim 22, wherein a filler having a surface energy less than about 35 dyne/cm is present in the polyimide layer or the base layer of the polyimide film .

27. The method according to claim 26, wherein the filler is a fluoropolymer or a siloxane polymer.

28. The method according to claim 26, wherein the filler is selected from a group consisting of polyvinylfluoride (PVF), polyfluorinated vinylidene (PVDF), polytetrafluoroethylene (PTFE), polyfluorinated ethylene propylene (FEP), perfluoropolyether (PEPE), perfluorosulfonic acid (PFSA) polymer, perfluoroalkoxy (PFA) polymer, chlorotrifluoroethylene (CTFE) polymer, ethylene chlorotrifuloroethylene (ECTFE) polymer, and a combination thereof.

29. The method according to claim 26, wherein the filler is in the form of particles having an average particle diameter less than about 20 μm.

30. The method according to claim 26, wherein the filler is present in the base layer in a quantity between about 45 wt % and about 60 wt % of a total weight of the base layer.
